(19) United States
(12) Patent Application Publication
(10) Pub. No.: US 2011/0183053 A1
(43) Pub. Date: Jul. 28, 2011

(54) PROCESS FOR REMOVAL OF CONTAMINATIONS FROM ORGANIC OILS

(76) Inventor: Dag Arntsen, Kolbjornsvik (NO)

(21) Appl. No.: 13/121,988

(22) PCT Filed: Jun. 26, 2009
(86) PCT No.: PCT/NO2009/000238

§ 371 Date: Mar. 31, 2011

(30) Foreign Application Priority Data
Oct. 3, 2008 (NO) 20084166

(51) Int. Cl. A23D 9/00; A23D 9/02

(52) U.S. Cl. 426/271; 426/601

(57) ABSTRACT

A process for removal of contaminants from marine and vegetable crude oils containing health hazardous amounts of contaminations, comprising the steps of: mixing a first absorbent material intimately into the oil until a homogenous suspension is obtained, mixing a second absorbent material intimately into the obtained suspension until a homogenous suspension is obtained, allowing the final suspension to rest, separating the oil phase from the absorbent materials with bound contaminants, and collecting the purified oil. The invention also comprises steps to produce the crude oil from a marine or vegetable raw material. The purified marine or vegetable oil is suited for use in food products for human and animal consumption.

The present invention relates to a process for the removal of contaminants from food oils derived from natural organic sources. In particular, the invention relates to a method for treatment of marine and vegetable oils to remove mainly all such contaminants as heavy metals, polychlorinated biphenyls (PCB), dioxines, flame retardants, and the like.

### BACKGROUND OF THE INVENTION

Commonly used oils intended for food products for human and animal consumption often contain unhealthy components which must be eliminated before consumption of the oils. Contaminations represent a serious problem, partly because of the increasing use of pesticides and chemicals in agriculture which leads to accumulation of toxic species in the environment. Therefore, oils for use in food products must be purified. To obtain commercial success, such a purifying process must be uncomplicated, and all contaminations must be removed. In addition, it is important that the levels of nutritionally valuable compounds and the oxidative status and stability of the oil is not altered during the processing.

### PRIOR ART

A number of procedures to purify food oils have been suggested.

Japanese Patent JP 5 086 394 discloses deodorization of an edible oil by bringing it into contact with chitosan. Preferred oils include palm oil, cocoa oil and coconut oil, lard, beef tallow and butter, which are heated to at least 60° C., and 1-20% by weight of chitosan is added. The processing time is in the range from tens of seconds to tens of minutes. Hydrocarbons, aldehydes and ketones are removed.

EP 1 332 774 A2 (corresponding to Japanese Patent 2003 22507) discloses a treatment method for removal of PCBs from oils and fats. A particulate adsorbent selected from a great number of materials, among others active carbon, chitosan, polymer resins and silica gel, is used. The particles have a diameter of 0.01 to 1 mm and a surface area of 100 to 3000 m²/g. The absorbent carries 0.5 to 10% by weight of a noble metal. A non-protonic polar solvent, such as acetone, acetonitrile, dimethyl-sulfoxide and tetrahydrofuran may be used. The PCB will dissolve in the solvent localized inside the pores of the adsorbent particles and is removed together with them.

WO 2007/016645 relates to the removal of contaminants from biodiesel by filtering the biodiesel together with particles of diatomaceous earth on which chitosan had been deposited. The hydrogenated polymer compounds in the diesel will attach to the chitosan coated particles. It is also disclosed preparation of chitosan solutions by dissolving chitosan in water and then adding hydrochloric acid to pH 5. In one embodiment chitosan is deposited onto diatomaceous earth suspended in water by adding a 1% chitosan solution, followed by sodium hydroxide to pH 7.

JP 2 115 298 relates to the separation of fish oil from waste liquor when processing fish and shell fish. The waste liquor is heated to a temperature not higher than 40° C., 1% by weight of chitosan is added, and the resulting mixture is centrifuged.

Nomanbhay, S. M. et al. “Removal of heavy metal from industrial wastewater using chitosan coated oil palm shell charcoal” in J. Biotechnology, 2005, Vol. 8, No. 1, describes removal of a great number of heavy metals from industrial wastewater effluence before being discharged to the environment.

Maes, J. et al. “Removal of dioxins from fish oil by activated carbon and its influence on the nutritional quality of the oil”, Journal of the American Oil Chemist's Society, 2005, vol. 82, No. 8, pp. 593-597, discloses the use of activated carbon to is remove contaminants such as dioxin and dioxin-like PCB from crude cod liver oil. Laboratory experiments showed that removal efficiencies were dependent on the grade and percentage of the activated carbon used.

EP 1084214B1 discloses a process for the preparation of cod liver oil with reduced content of polychlorinated dioxins, furans, biphenyls and polycyclic aromatic hydrocarbons by refining with acid and/or alkali, treatment with activated carbon, and deodorization with hot steam.

None of the above-mentioned treatment methods allow simultaneous removal of all types of contaminations from oils. In addition, prior art processes involve many steps and are not particularly suited for industrial treatment of marine and vegetable oils. In general, current oil treatment methods usually include a final step, such as heat treatment at a relatively high temperature followed by filtering to remove the contaminants. Heat treatment tends to destroy important antioxidants, vitamins and nutritionally valuable microcompounds in the oil, and the oil will more easily become rancid.

Thus, there is still a demand for a simplified process which removes all contaminants simultaneously and is performed at a relatively low temperature to secure that naturally occurring valuable ingredients (antioxidants, vitamins and microcompounds) in the oil remain in their original state. This object is achieved with the process of the present invention. The present decontamination process has no adverse influence on the oil itself, and the oil is not oxidized or degraded because the process is operated at a relatively low temperature. The process can be performed by the use of a simple apparatus, and the contaminations may be separated by utilizing well known separation techniques.

Thus, the object of the present invention is to purify vegetable and marine oils by a simplified process to obtain that the content of contaminations be reduced to a level well below those values accepted by health authorities, and maintaining essentially all nutrionally valuable compounds such as vitamins, antioxidants and similar.

### SUMMARY OF THE INVENTION

This invention provides a process for removal of contaminants from marine and vegetable crude oils containing health hazardous amounts of contaminations, comprising the steps of:

(1) mixing a first absorbent material intimately into the marine oil or vegetable oil until a homogenous suspension is obtained, said first absorbent material is selected from the group comprising chitosan, carageenan, collagene and alginates,
(2) mixing a second absorbent material intimately into the suspension obtained in step (1) until a homogenous suspension is obtained, said second absorbent material is selected from the group comprising activated carbon, bentonite, diatomaceous earth, limestone, coral sand, and ion exchangers, or mixtures thereof,
(3) allowing the suspension obtained in step (2) to rest,
(4) separating the oil phase from the absorbent materials with bound contaminants,
(5) collecting the purified oil.

The process of the invention may further comprise the following steps to produce the crude oil: (i) providing a marine or vegetable raw material, (ii) comminuting the raw material into a raw material mass, and adding an aqueous chitosan solution thereto, (iii) separating the mass obtained in step (ii) into a liquid phase and a solid phase, (iv) separating crude oil from the liquid phase in step (iii), and (v) collecting the crude oil.

An object of the invention is also the purified marine or vegetable oil obtained by the process of the invention.

The purified marine or vegetable oil obtained by the present process is suited for use in food products for human and animal consumption.

### BRIEF DESCRIPTION OF THE FIGURES

FIG. 1 shows a process for the production of a crude oil

FIG. 2 shows a receptacle suited for use in the process of the invention.

FIG. 3 shows the same receptacle provided with a mixing device. The receptacle can also be provided with a heating jacket for temperature control.

### DETAILED DESCRIPTION OF THE INVENTION

The present invention relates to a process for providing marine or vegetable oils free of contaminants.

The terms “free of contaminants”, “removal of contaminations” and similar, as used herein, mean that the content of foreign and potentially unhealthy compounds is well below the threshold values set by governmental bodies or health authorities to be acceptable in food products.

The preparation of edible oils derived from vegetable or marine sources can be based on the use of any suitable raw material, such as oil containing vegetables or marine organisms.

Marine organisms will comprise all types of whole fish; crustaceans; cutoffs in the preparation of products from fish, aquatic animals and organisms; and waste material from the preparation of products therefrom, and similar.

Vegetables comprise, for the object of the present invention, all plants and fruits conventionally used in the production of a vegetable oil.

Chitosan is prepared by diacetylation of chitin with an alkaline solution. The production of chitosan is well known to the person skilled in the art and is described in detail in textbooks and in prior art publications. Every type of chitosan can be used in the present invention, such as chitosan derived from crustaceans, shrimps, crawfish, connecting tissues and cartilage from animals and birds, and insects. Chitosan may also be used as hydrolyzed chitosan, salts of chitosan and glucosamides of chitosan. The chitosan used in the present invention has a deacetylation degree of about 20% to 100%.

Water used in the present invention is clean water, such as drinking water of accepted quality for use in the food processing industry.

The decontamination process of the present invention comprises two main steps: a crude oil producing step and a refining step. In the crude oil producing step the raw material is first comminuted by being crushed, milled or ground, or similar, into a raw material mass which subsequently is subjected to a treatment as explained below to obtain a crude oil phase. In the refining step the crude oil is decontaminated to a desired final quality.

In the initial crude oil producing step essentially all proteins are removed from the raw material. Conventionally, this is done by dissolving the proteins by adding an acid solution to the comminuted raw material mass. This mixture is then worked up to obtain a crude oil. The aqueous liquid phase comprising proteins and acidic species must be subjected to a cleaning process before being disposed of to avoid pollution of the environment.

It has now been found that instead of adding an aqueous acid to the raw material to dissolve the proteins, the addition of an aqueous chitosan solution results in a solid protein mass which can easily be collected and safely disposed of. The process is far more simple and efficient than the conventional acid solution process currently used.

The obtained crude oil is then subjected to a process for removal of contaminants. In this refining process a first absorbent is suspended into the crude oil. This first absorbent may be selected from the group consisting of chitosan, carageenan, collagen and alginates, and mixtures thereof. Chitosan is preferred. The chitosan is suitably used in the form of a “purification” solution as specified below.

When the first absorbent has been suspended in the oil, a second absorbent is added. This second absorbent may be selected from the group consisting of activated carbon, bentonite, diatomaceous earth, limestone, coral sand, and ion exchangers, and mixtures thereof. Activated carbon in powder form is preferred.

Preferably, chitosan is used both in the first crude oil producing step and in the second oil refining step. This will simplify an integrated process from raw material to is the final purified oil.

Crude marine and vegetable oils are available commercially. The initial crude oil producing step and the subsequent oil refining step represent two independent steps sharing the same inventive concept. Thus, the initial crude oil producing step starting from natural, raw materials may be omitted if the crude oil could be bought from another producer. This initial step represents an embodiment of the present invention.

In principle, the chitosan could be mixed directly with the raw material or the crude oil, but since chitosan is insoluble in oils it is preferred to add the chitosan as a chitosan-containing “purification” solution. Such a solution is preferably a concentrated aqueous solution prepared by dissolving about 1% by weight of chitosan flakes in water to which it is added about 1% by weight of acid, wherein the percentages are based on the weight of the water. The acid may be any suitable acid, preferably hydrochloric acid, acetic acid or glycolic acid, most preferred glycolic acid (hydroxy-acetic acid). This “purification” solution may in principle contain any concentration of chitosan. For practical reasons a 1% by weight solution is found to be suitable, but the invention is not restricted to exactly this level.

The present process will now be described in more detail by reference to the figures.

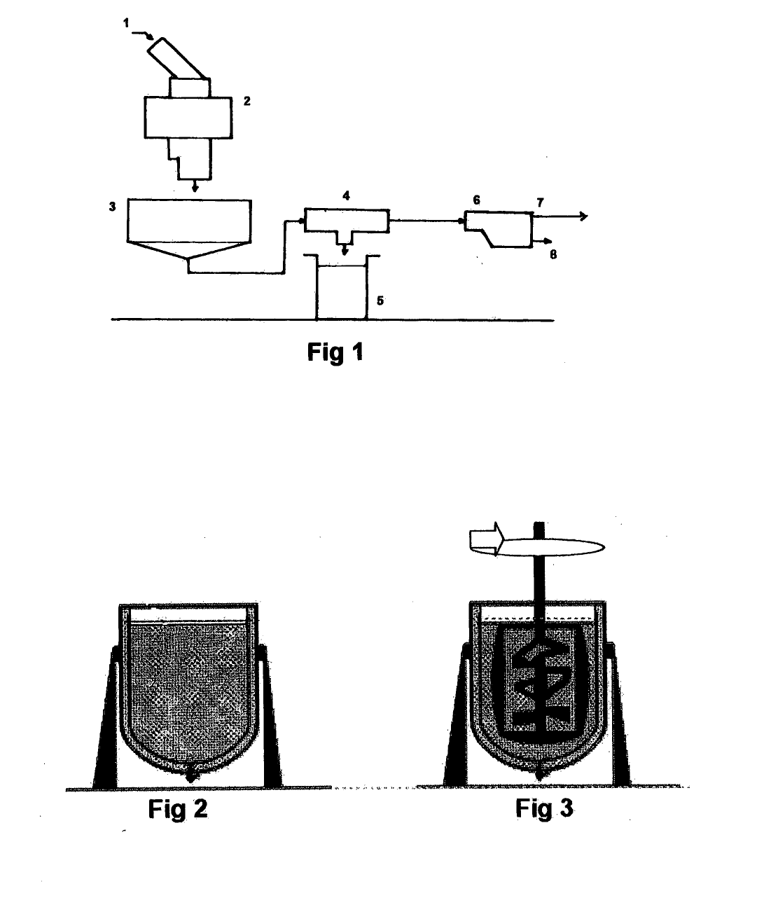

The initial step of the process of the present invention is a crude oil producing step. An example of such a process is depicted in FIG. 1. First, a suitable raw material, 1, is milled in a raw material mill, 2. The obtained milled mass is conveyed to a vessel, 3, and the chitosan solution specified above is added to the stirred mass in an amount of about 10 liters of chitosan solution per 10 kilograms of raw material mass. The mixture thus obtained may at this stage be recovered and optionally frozen for later use, because the chitosan provides a very good shelf life. The mixture is then fed into a decanter, 4, wherein the liquid phase is separated from the solids. The solids collected in a vessel, 5, are disposed of. The liquid phase is fed to a separator, 6, wherein the oil is separated from the proteins and the aqueous phase. The crude oil, 7, is fed to a container for subsequent use in the further purification process.

In this crude oil producing process it is important to add the chitosan solutions already in the initial phase of the process, as indicated above. Thereby the chitosan will bind proteins and pollutions, which can then be removed as a solid protein containing phase.

The oil, 7, is then subjected to a following oil decontamination process. A suitable vessel for use in the process of the present invention is depicted in FIGS. 2 and 3. The reactor vessel (see FIG. 2) can be of any suitable size. Preferably it is provided with an outside jacket for circulation of thermostated water or suitable liquid to keep the temperature in the oil in the vessel at a specified constant temperature. For an efficacious mixing, a suitable stirring device with controllable speed can be used, as indicated in FIG. 3. The oil is heated to a temperature preferably within the range from 10° C. to 70° C., more preferred in the range from 20° C. to 50° C., most preferred to about 40° C., under gentle stirring. All steps in this further purification process are performed at approximately the same temperature.

To prevent oxidation of the oil, i.e. to avoid that it becomes rancid or decay, the oxygen in the atmosphere above the oil may be displaced by an inert gas. The entire process, or at least the first step of this process may be performed in an inert atmosphere at about ambient pressure, or preferably at a pressure in the range from about 1 to 2 bar gauge. For practical and economic reasons, nitrogen may be used as the inert gas. The reaction vessel must in this case be a closed reactor. The use of an inert atmosphere will depend on the type of oil to be treated.

The first absorbent is then added to the heated oil under vigorous stirring until a homogenous mixture is obtained. It is important to obtain an intimate blending of the absorbent into the oil.

As the first absorbent, the chitosan solution specified above is preferably used. The solution is added in an amount corresponding to 1 to 10 grams, preferably about 2 grams, of chitosan per kilogram of oil to be purified. The amount of added chitosan is not critical. If a lower amount is used, the result may be unsufficient purification. On the other hand, a higher amount may not give any additional effect, confer example 11.

When adding the chitosan solution, the oil will change its color from a bright yellow color to a turbid, yellow-white color. This indicates that the contaminations have been absorbed by the chitosan and that they are present as a suspension in the oil. The oil is then gently stirred while maintaining the temperature.

When the absorption of the contaminants on the chitosan is finished, the second absorbent is added. The preferred second absorbent is activated carbon. The purpose of using a second absorbent is that this second absorbent will combine with the first absorbent particles into greater particles which will more easily precipitate. This will facilitate the removal of all polluting compounds and contaminants from the reaction mixture in a simple way.

The amount of added activated carbon is in no way critical. It must be high enough to obtain an effect. On the other hand, for practical and economical reasons it should be kept as low as possible. A suitable amount would be in the range from about 2 to 10 grams of activated carbon per kg of oil, preferably about 6 grams of activated carbon per kg of oil. Best results are obtained with a powder of activated carbon. The carbon powder is strewn onto the oil under vigorous stirring to obtain a good contact with the chitosan particles having absorbed contaminants. As soon as the reaction mixture has become homogenous, the stirring is reduced to a gentle stirring for a short period of time, and then the oil mixture is allowed to rest. The combined absorbent particles carrying the contaminants will then precipitate into a bottom layer which may be separated by any common means, such as by use of a filtering device, centrifuge, decanter or similar, or even a combination of these methods.

Operating parameters, such as speed of stirring, time periods of stirring and rest, temperatures, etc., in each step, will depend on the type of equipment and devices, the nature of the raw material, the nature of the oil, the amount of pollution and contaminants, and similar.

A person skilled in the art will easily be able to determine the optimal parameters by routine experimentation.

As a routine, for controlling and securing the quality of the oil, samples are withdrawn from each batch and analysed. The final product is then pumped into a suitable container for storage or shipment.

The final product is a clear, pure oil free of objectionable odor and flavor, heavy metals and organic contaminants.

It is highly surprising that pollutions and contaminations can be removed from oils by the use of chitosan, because it is well known to the person skilled in the art that chitosan binds to the oil itself. For example, chitosan contacted with mineral oil creates one hard lump. Therefore, in view of experience it is very surprising that decontamination of organic oils by the use of chitosan is at all possible. It is also surprising that chitosan and activated carbon will have a synergistic effect. It seems that chitosan carrying absorbed contaminants when contacted with activated carbon will associate into greater solid particles comprising chitosan, activated carbon and contaminants. These particles will easily precipitate and the supernatant oils can be decanted or drawn off.

### INDUSTRIAL APPLICABILITY

The present invention provides an industrial process for the decontamination of all types of vegetable and marine oils for use in food products. The process is simple and cost efficient. Common reactor vessels, equipments and devices can be used.

### EXAMPLES

The invention shall now be elucidated in more detail by the following examples, which shall not be interpreted as a limitation of the scope of the invention.

In the examples the following abbreviations are used:

BB—brominated biphenyl
BDE—brominated diphenylether
DDD—2,2-bis(p-chlorophenyl)-1,1-dichloroethane
DDE—dichlorodiphenyldichloroethylene
DDT—dichlorodiphenyltrichloroethane
PAH—polyaromatic hydrocarbon
PCB—polychlorinated biphenyl
PCDD—polychlorinated dibenzodioxide
nd—not detectable or below the limit for quantification.

### Example 1

To determine the obtainable extent of decontamination of a marine oil by the use of the present invention, an experiment was performed with shark oil.

Shark oil is a commodity and the provided batch of shark oil was analysed. The total amount of contaminations, defined as the total amount of dioxins, furans and dioxin resembling PCB, was found to be 67 picograms of contaminations per gram of oil.

The shark oil was filled into a reactor vessel equipped with a heating jacket and a stirring device. The oil was heated to about 40° C. under gentle stirring and kept at this temperature during the entire decontamination process.

A premade 1% aqueous solution of chitosan was poured into the oil under vigorous stirring, in an amount of about 2 g of chitosan per kg of oil. As soon as an homogenous mixture was obtained, the stirring was reduced to a gentle stirring. The oil now changed color from a transparent yellow to a turbid off-white/yellow color. The activated carbon powder was then strewn onto the oil under vigorous stirring. As soon as the carbon powder had been mixed into the oil, the stirring was reduced to a gentle stirring for a few minutes, and the oil was then allowed to rest. The formed solids were allowed to precipitate, and then the supernatant oil was collected by the use of a pumping device and conveyed to a storing bank. The oil was analysed for contaminations. The result is presented in table 1.

### Example 2

### Comparative Example

Example 1 was repeated, except that the activated carbon was used as pellets in stead of powder. The result is presented in table 1.

### Examples 3 and 4

### Comparative Examples

The procedure of example 1 was followed, except that the chitosan solution was replaced with an aqueous hydrochloric acid solution in a sufficient amount to obtain pH 5 and pH 3, respectively. Activated carbon was not used. The result is presented in table 1.

### Example 5

Salmon oil, which is a commodity, was provided and analysed. The total amount of contaminations, defined as the total amount of dioxins, furans and dioxin resembling PCB, was found to be 9,9 picograms of contaminations per gram of oil.

The salmon oil was purified in the same way as disclosed in example 1. The result is presented in table 1.

### Example 6

### Comparative Example

Example 5 was repeated, except that activated carbon was used as pellets in stead of powder. The result is presented in table 1.

The results from examples 1 to 6 presented in table 1 below show that the decontamination process of the present invention by using activated chitosan followed by carbon powder provides the significantly best effect. This is true both for shark oil (example 1) and salmon oil (example 6).

TABLE 1

| | | | Contaminations |
|---|---|---|---|
| | | | (dioxins, furans, |
| Example | | Treatment with | dioxin-like PCB in |
| No. | Oil | chitosan+ | pg per g oil) |
| — | Shark oil | Not treated | 67 |
| 1 | Shark oil | Activ. carbon powder | 2.7 |
| 2 comp. | Shark oil | Activ. carbon pellets | 10 |
| 3 comp. | Shark oil | pH 5 | 13 |
| 4 comp | Shark oil | pH 3 | 41 |
| — | Salmon oil | Not treated | 9.9 |
| 5 | Salmon oil | Activ. carbon powder | 1.9 |
| 6 comp. | Salmon oil | Activ. carbon pellets | 8.7 |

### Example 7

A fish oil of common commercial quality untreated (F0) and subjected to the decontamination process of the present invention (F1) was analysed for organic contaminations, such as halogen-containing compounds. The results of the analyses are presented in tables 2 to 5 below.

TABLE 2
Polychlorinated biphenyl (PCB)

| | F0 | F1 |
|---|---|---|
| Component | ng/g oil | ng/g oil |
| TriCB(#28) | 2.32 | 0.95 |
| TetraCB(#52) | 19.60 | 17.00 |
| PentaCB(#101) | 91.20 | 84.10 |
| PentaCB(#118) | 70.00 | 37.90 |
| HexaCB(#138) | 166.00 | 160.00 |
| HexaCB(#153) | 269.00 | 243.00 |
| HeptaCB(#180) | 74.90 | 69.30 |

TABLE 3
Brominated diphenylether (BDE) and brominated biphenyl (BB)

| | F0 | F1 |
|---|---|---|
| Component | μg/kg | μg/kg |
| TriBDE | 0.75 | 0.42 |
| TetraBDE | 65.2 | 51.7 |
| PentaBDE | 36.9 | 31.6 |
| HexaBDE | 6.49 | 5.50 |
| HeptaBDE | ND | ND |
| OctaBDE | ND | ND |
| NonaBDE | ND | ND |
| DekaBDE | <0.35 | <0.85 |
| TetraBB | 0.22 | 0.19 |
| PentaBB | 0.20 | 0.19 |
| Hexa BB | 0.28 | 0.25 |
| HeptaBB | <0.02 | <0.02 |
| OctaBB | <0.98 | <0.42 |
| NonaBB | <0.06 | <0.07 |
| DekaBB | <0.19 | <0.21 |

TABLE 4
Polyaromatic hydrocarbons (PAH)

| | F0 | F1 |
|---|---|---|
| Component | μg/kg | μg/kg |
| Fluorene | 2.4 | <0.5 |
| Phenenthrene | 5.5 | <0.5 |
| Anthracene | <0.5 | <0.5 |
| Fluoranthene | 2.0 | <0.5 |
| Pyrene | <0.5 | <0.5 |

TABLE 5
Pesticides

| | F0 | F1 |
|---|---|---|
| Component | ng/g | ng/g |
| o,p-DDT | 103 | 83 |
| p,p′-DDT | 198 | 186 |
| o,p-DDD | 17 | 20 |
| p,p′-DDD | 44 | 56 |
| o,p-DDE | <0.4 | <1.0 |
| p,p′-DDE | 110 | 122 |
| Pentachlorobenzene | 1.7 | <0.6 |
| Hexachlorobenzene | 16 | 3.1 |
| Toxafene 26 | 15 | 12 |
| Toxafene 50 | 21 | 17 |
| Toxafene 62 | <5 | <4 |
| Octachlorostyrene | 13 | 15 |
| Dieldrin | 18 | 19 |
| Endrin | 2.5 | 2.2 |
| Mirex | 1.1 | 0.77 |

### Example 9

A fish oil of common commercial quality untreated (F0) and subjected to the decontamination process of the present invention (F1) was analysed for heavy metals. The results of the analyses are presented in table 6 below.

TABLE 6
Heavy metals

| | F0 | F1 |
|---|---|---|
| Metall | mg/kg | mg/kg |
| Lead (Pb) | <0.10 | <0.1 |
| Cadmium (Cd) | <0.01 | <0.01 |
| Mercury (Hg) | <0.005 | <0.005 |
| Arsenic (As) | 5.5 | 2.8 |
| Copper (Cu) | <0.1 | <0.1 |
| Iron (Fe) | <0.1 | 0.45 |
| Sodium (Na) | 4.6 | <3 |
| Selenium (Se) | <0.2 | <0.2 |

### Example 10

To determine whether essential fatty acids or vitamins remain in the oils after being subjected to the purification process, shark oil as obtained (F0) and decontaminated according to the present invention (F1) was analysed for fatty acid composition and for vitamins. The results are presented in table 7. Fatty acid components in amounts less than 0.1% by weight, based on the complete oil sample, have been excluded. Uncertainty in measurements: ±20% for components in amounts less than 5% by weight, and ±10% for components in higher amounts.

The results reveal that the amount of cholesterol will be substantially lowered, while the content of most of the other fatty acid components and vitamins remain essentially unchanged after the purification process.

TABLE 7
Fatty acids, components and vitamins

| | Unit | F0 | F1 |
|---|---|---|---|
| Cholesterol | mg/100 g | 1197 | 951 |
| saturated fatty acids | % | 4.7 | 5.0 |
| single unsaturated fatty acids % | % | 92.0 | 91.4 |
| polyunsaturated fatty acids | % | 2.1 | 2.1 |
| Total fatty acids | % | 98.8 | 99.0 |
| percentage of fatty acids: | | | |
| Myristic acid C14 | % | 0.6 | 0.6 |
| Palmitic acid C16 | % | 3.2 | 3.5 |
| Palmitolic acid C16:1 | % | 0.8 | 0.8 |
| Stearic acid C18 | % | 0.6 | 0.6 |
| Oleic acid C18:1 | % | 5.3 | 5.7 |
| Linoleic acid C18:2-6 | % | 0.2 | 0.2 |
| alfa-linolenic acid C18:3-3 | % | 0.2 | 0.1 |
| Gadoleic acid C20:1 | % | 3.6 | 4.0 |
| EPA C20:5-3 | % | 0.3 | 0.4 |
| C22:1 | % | 10.5 | 11.8 |
| DHA C22:6-3 | % | 1.0 | 1.0 |
| Tetracosenic acid C24:1 | % | 71.8 | 69.6 |
| Total omega 3-fatty acids | % | 1.7 | 1.7 |
| Total omega 6-fatty acids | % | 0.4 | 0.4 |
| Omega 6/omega 3 | | 0.24 | 0.24 |
| Vitamin D3 | μg/100 g | <0.5 | <0.5 |
| Vitamin A | μg/100 g | 8620 | 7790 |
| Vitamin E | μg/100 g | 38.3 | 31.8 |
| Antioxidative, Trolox equiv. | μg/ml | 191 | 176 |

### Example 11

In this example it was investigated to which degree a repetition of the purification process would influence the quality of the fish oil. A cod liver oil was subjected to two identical consecutive decontamination processes according to the present invention. The cod liver oil was analysed as received (commodity) (F0), after being subjected to the decontamination process of the present invention one time (F1) and two times (F2).

The results of analyses for selected components are presented in table 8.

The results reveal great changes from unpurified oil to one time purified oil, and that the changes are minor from one to two times purification.

TABLE 8

| Component | unit | F0 | F1 | F2 |
|---|---|---|---|---|
| PCDD | pg/g | 8.5 | ND | ND |
| d,l-PCB | pg/g | 12.0 | 0.81 | 0.90 |
| PCB 28 | ng/g | 6.11 | 1.04 | 0.75 |
| PCB 52 | ng/g | 13.10 | 9.37 | 9.27 |
| PCB 101 | ng/g | 20.80 | 18.30 | 17.60 |
| PCB 118 | ng/g | 23.00 | 10.20 | 7.24 |
| PAH fluorene | ng/g | 1.6 | ND | ND |
| PAH phenanthrene | ng/g | 3.8 | ND | ND |
| PAH fluorantene | ng/g | 1.2 | ND | ND |
| o,p-DDT | ng/g | 6.7 | 4.8 | 4.7 |
| p,p′-DDT | ng/g | 15 | 14 | 14 |
| o,p-DDD | ng/g | 5.7 | 4.3 | 4.2 |
| p,p′-DDD | ng/g | 26 | 23 | 23 |
| o,p-DDE | ng/g | 1.1 | 0.74 | 0.71 |
| p,p′-DDE | ng/g | 86 | 77 | 77 |
| Dieldrin | ng/g | 44 | 35 | 35 |
| Toxafene 26 | ng/g | 46 | 38 | 38 |
| Toxafene 50 | ng/g | 108 | 52 | 92 |
| Toxafene 62 | ng/g | 38 | 35 | 35 |
| As Arsenic | mg/g | 2.6 | 0.87 | 0.89 |

The present invention has been exemplified with certain marine oils. A person skilled in the art will realize that the present invention can be used for the purification of all types of marine and vegetable oils. Thus, the invention shall not be restricted to the specific types of oils exemplified, but will encompass all equivalent embodiments. Modifications, variations and improvements of the present process may be obvious to a person skilled in the art without departing from the spirit and scope of the invention defined by the following claims.

1. A process for removal of contaminants from marine and vegetable crude oils containing health hazardous amounts of contaminations, comprising the steps of:
(1) mixing a first absorbent material intimately into the marine oil or vegetable oil until a homogenous suspension is obtained, said first absorbent material is selected from the group comprising chitosan, carageenan, collagene and alginates,
(2) mixing a second absorbent material intimately into the suspension obtained in step (1) until a homogenous suspension is obtained, said second absorbent material is selected from the group comprising activated carbon, bentonite, diatomaceous earth, limestone, coral sand, and ion exchangers, or mixtures thereof,
(3) allowing the suspension obtained in step (2) to rest,
(4) separating the oil phase from the absorbent materials with bound contaminants,
(5) collecting the purified oil.

2. The process of claim 1, wherein the first absorbent is chitosan.

3. The process of claim 2, wherein the chitosan is added in an amount of 1 to 10 grams of chitosan per 1 kilogram of oil.

4. The process of claim 3, wherein the chitosan is added as an about 1% by weight aqueous solution of chitosan.

5. The process of claim 1, wherein the second absorbent is activated carbon.

6. The process of claim 1, wherein the activated carbon in the form of a powder is added in an amount of 1 to 10 grams of activated carbon per 1 kilogram of oil.

7. The process of claim 1, wherein step (1) is performed in an inert atmosphere.

8. The process of claim 1, wherein steps (1) to (4) are performed at a temperature in the range of about 20° C. to about 50° C.

9. The process of claim 1, further comprising the following steps to obtain the crude oil:
(i) providing a marine or vegetable raw material,
(ii) comminuting the raw material into a raw material mass, and adding an aqueous chitosan solution thereto,
(iii) separating the mass obtained in step (ii) into a liquid phase and a solid phase,
(iv) separating crude oil from the liquid phase in step (iii), and
(v) collecting the crude oil.

10. The process of claim 9, wherein the aqueous chitosan solution added in step (ii) is added as an about 1% by weight aqueous chitosan solution in an amount of about 1 liter of chitosan solution per 10 kilograms of raw material.

11. A purified marine or vegetable oil, obtained by the process of claim 1.

12. A use of the purified marine or vegetable oil of claim 11, in food products for human and animal consumption.
